(19) United States
(12) Patent Application Publication
(10) Pub. No.: US 2014/0342136 A1
(43) Pub. Date: Nov. 20, 2014

(54) MEMBER WITH SEALING MATERIAL LAYER, ELECTRONIC DEVICE, AND METHOD OF MANUFACTURING ELECTRONIC DEVICE

(71) Applicant: ASAHI GLASS COMPANY, LIMITED, Chiyoda-ku (JP)

(72) Inventors: Yohei NAGAO, Chiyoda-ku (JP); Ryota MURAKAMI, Chiyoda-ku (JP); Yoichi SERA, Chiyoda-ku (JP)

(73) Assignee: ASAHI GLASS COMPANY, LIMITED, Chiyoda-ku (JP)

(21) Appl. No.: 14/271,731

(22) Filed: May 7, 2014

(30) Foreign Application Priority Data
May 15, 2013 (JP) 2013-102741

(51) Int. Cl. B32B 17/00; B32B 37/00

(52) U.S. Cl. CPC B32B 17/00; B32B 37/0038; B32B 2307/20; B32B 2457/00
USPC 428/210; 428/426; 156/182

(57) ABSTRACT

It is an object to provide a member with a sealing material layer having good sealability when low-power sealing laser light is used. A member with a sealing material layer includes a substrate having a sealing region on a surface; and a sealing material layer on the sealing region and containing sealing glass and a low-expansion filler, wherein the sealing material layer has a first region on the substrate side with respect to a center of the layer and a second region opposite the substrate with respect to the center, and has, in a cross section taken along the thickness direction of the sealing material layer, a part where a ratio A/B between a proportion “A” of an area of the low-expansion filler in the first region and a proportion “B” of an area of the low-expansion filler in the second region is less than 1.0.

### CROSS-REFERENCE TO RELATED APPLICATION

This application is based upon and claims the benefit of priority from the prior Japanese Patent Application No. 2013-102741, filed on May 15, 2013; the entire contents of all of which are incorporated herein by reference.

### FIELD

The present invention relates to a member with a sealing material layer, an electronic device, and a method of manufacturing an electronic device.

### BACKGROUND

A flat panel display (FPD) such as an organic EL (electro-luminescence) display (OELD) and a plasma display panel (PDP) has a structure in which light-emitting elements are sealed by a glass package in which a pair of glass substrates are sealingly bonded. A liquid crystal display (LCD) also has a structure in which liquid crystals are sealed between a pair of glass substrates. Further, a solar cell such as an organic thin-film solar cell and a dye-sensitized solar cell also has a structure in which solar cell elements (photoelectric conversion elements) are sealed between a pair of glass substrates.

Sealing glass is suitably used for sealing. In the sealing by the sealing glass, for example, a sealing material layer containing the sealing glass is disposed in a frame shape between a pair of glass substrates to form a glass assembly, and this sealing material layer is heated to 400 to 600° C. At this time, when the whole glass assembly is heated by using a firing furnace, an electronic element part such as light emitting elements is likely to be damaged by the heating. Therefore, the application of laser sealing that heats only the sealing material layer by using laser light (sealing laser light) has been considered.

Concretely, the laser sealing is done as follows. First, the sealing glass is mixed with a vehicle to prepare a sealing material paste. This sealing material paste is applied on a frame-shaped sealing region of one of the glass substrates on which the electronic element part is not mounted, to form a frame-shaped coating layer, and the frame-shaped coating layer is heated to a firing temperature of the sealing glass (temperature equal to or higher than a softening temperature of the sealing glass). Consequently, the sealing glass is melted and is baked to the glass substrate, so that the sealing material layer is formed. Next, the glass substrate having the sealing material layer and the other glass substrate on which the electronic element part is mounted are stacked via the sealing material layer, and thereafter, the sealing laser light is radiated to the sealing material layer via the glass substrate to heat and melt the sealing material layer. Consequently, the pair of glass substrates are joined by a sealing layer.

It has conventionally been known to enhance surface smoothness of the sealing material layer to thereby enhance its adhesiveness with the glass substrate on which the electronic element part is mounted and perform sealing by low-power sealing laser light. Concretely, a first sealing material paste is applied on the glass substrate on which the electronic element part is not mounted to form a first sealing material film, and thereafter, a second sealing material paste is applied on the first sealing material film to form a second sealing material film. At this time, the content of a fire-resistant filler in the second sealing material paste is set smaller than the content of the fire-resistant filler in the first sealing material paste. By firing such a film stack to form the sealing material layer, surface smoothness of the sealing material layer is improved and its adhesiveness with the glass substrate on which the electronic element part is mounted is improved as described above (for example, refer to Patent Reference 1: JP-A 2013-49615).

### SUMMARY

However, the conventional sealing material layer does not necessarily have sufficient sealability when the low-power sealing laser light is used, and there is a demand for improvement in its sealability. Concretely, it is required to reduce damage of the glass substrate at the time of the sealing while realizing good airtightness after the sealing. Further, in order to improve handlablity of the glass substrate on which the sealing material layer is formed, it is required to improve adhesive strength between the glass substrate and the sealing material layer.

The present invention was made in order to solve the aforesaid problems and has an object to provide a member with a sealing material layer having good sealability by low-power sealing laser light. Another object of the present invention is to provide an electronic device which is sealed well by using such a member with a sealing material layer. Still another object of the present invention is to provide a method of manufacturing such an electronic device.

A member with a sealing material layer of the present invention includes: a substrate having a frame-shaped sealing region on a main surface; and a sealing material layer provided on the sealing region and containing sealing glass and a low-expansion filler, wherein the sealing material layer has a first region on the substrate side with respect to a center of the layer in terms of a thickness direction and a second region opposite the substrate with respect to the center, and has, in a cross section taken along the thickness direction of the sealing material layer, a part where a ratio A/B between a proportion “A” of an area of the low-expansion filler occupying an area of the first region and a proportion “B” of an area of the low-expansion filler occupying an area of the second region is less than 1.0.

An electronic device of the present invention includes: a first substrate having a first surface on which a frame-shaped first sealing region is provided; a second substrate having a second surface on which a second sealing region corresponding to the first sealing region is provided and disposed with the first surface and the second surface facing each other; and a sealing layer disposed in a frame shape so as to seal an electronic element part between the first substrate and the second substrate, wherein the sealing layer is formed by melting and bonding a sealing material layer provided on the second sealing region of the second substrate and containing sealing glass and a low-expansion filler, a dispersion state of the low-expansion filler in a cross section taken along a thickness direction of the sealing layer is the same as a dispersion state of the low-expansion filler in a cross section taken along a thickness direction of the sealing material layer, the sealing layer has a third region on the second substrate side with respect to a center of the sealing layer in terms of the thickness direction and a fourth region opposite the second substrate with respect to the center, and has, in a cross section taken along the thickness direction of the sealing layer, a part where a ratio C/D between a proportion “C” of an area of the low-expansion filler occupying an area of the third region and a proportion “D” of an area of the low-expansion filler occupying an area of the fourth region is less than 1.0.

A method of manufacturing an electronic device of the present invention includes: a substrate preparation step, a first coating step, a second coating step, a firing step, a stacking step, and a sealing step. The substrate preparation step prepares a first substrate having a first surface on which a frame-shaped first sealing region is provided and a second substrate having a second surface on which a second sealing region corresponding to the first sealing region is provided. The first coating step applies a first sealing material paste prepared by mixing a first sealing material containing sealing glass and a low-expansion filler with a vehicle containing an organic binder, on the second sealing region of the second substrate to form a first frame-shaped coating layer. The second coating step applies a second sealing material paste prepared by mixing a second sealing material containing sealing glass and a low-expansion filler with a vehicle containing an organic binder, on the first frame-shaped coating layer to form a second frame-shaped coating layer. The firing step heats the first frame-shaped coating layer and the second frame-shaped coating layer to form a sealing material layer. The stacking step stacks the first substrate and the second substrate via the sealing material layer, with the first surface and the second surface facing each other. The sealing step irradiates the sealing material layer with sealing laser light through the second substrate to melt the sealing material layer to form a sealing layer sealing an electronic element part provided between the first substrate and the second substrate. A ratio a/b between a volume content proportion “a” of the low-expansion filler in the first sealing material and a volume content proportion “b” of the low-expansion filler in the second sealing material is less than 1.0.

According to the present invention, it is possible to provide a member with a sealing material layer whose sealability and so on when low-power sealing laser light is used can be high. Further, according to the present invention, it is possible to provide an electronic device which is sealed well. Further, according to the method of manufacturing the electronic device of the present invention, it is possible to manufacture an electronic device which is sealed well.

### BRIEF DESCRIPTION OF THE DRAWINGS

FIG. 1A is a cross-sectional view illustrating a manufacturing step of an electronic device.

FIG. 1B is a cross-sectional view illustrating a manufacturing step of the electronic device.

FIG. 1C is a cross-sectional view illustrating a manufacturing step of the electronic device.

FIG. 1D is a cross-sectional view illustrating a manufacturing step of the electronic device.

FIG. 2 is a plane view illustrating a first substrate having an electronic element part.

FIG. 3 is a cross-sectional view of the first substrate taken along A-A line in FIG. 2.

FIG. 4 is a plane view illustrating a second substrate having a sealing material layer.

FIG. 5 is a cross-sectional view of the second substrate taken along B-B line in FIG. 4.

FIG. 6 is a cross-sectional view schematically illustrating a part where a ratio NB is less than 1.0 in the sealing material layer.

FIG. 7A is a cross-sectional view illustrating a formation step of the sealing material layer.

FIG. 7B is a cross-sectional view illustrating a formation step of the sealing material layer.

FIG. 7C is a cross-sectional view illustrating a formation step of the sealing material layer.

FIG. 8 is a cross-sectional view schematically illustrating a part where a ratio C/D is less than 1.0 in a sealing layer.

### DETAILED DESCRIPTION

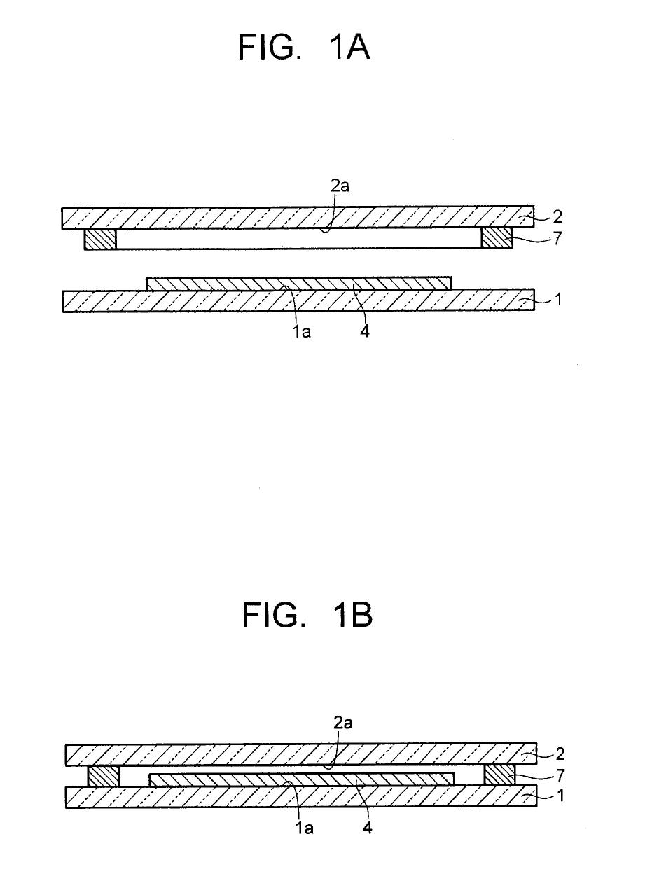

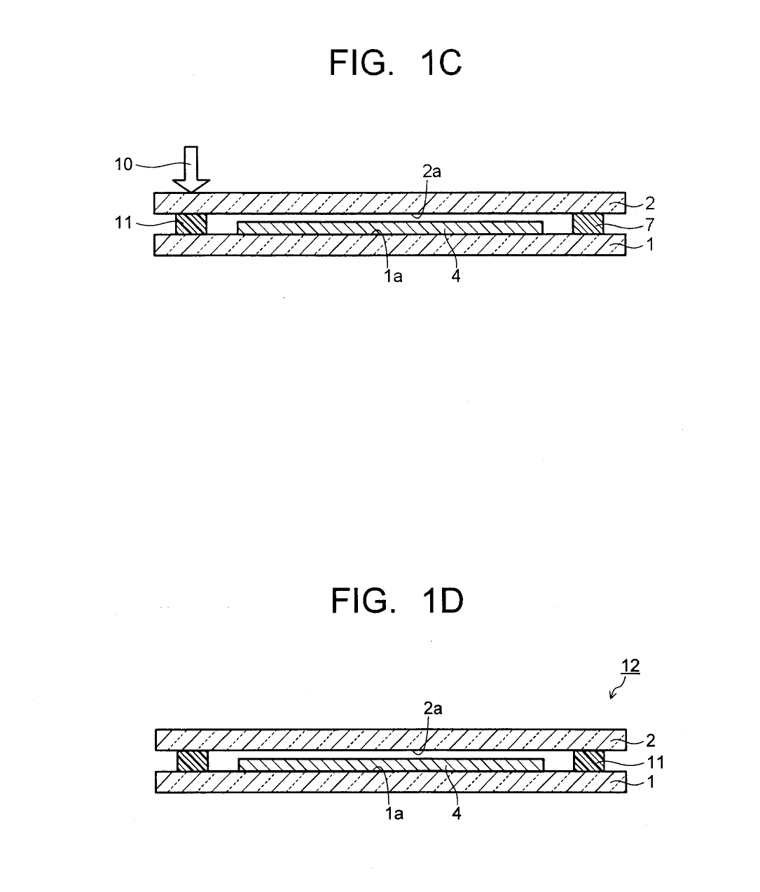

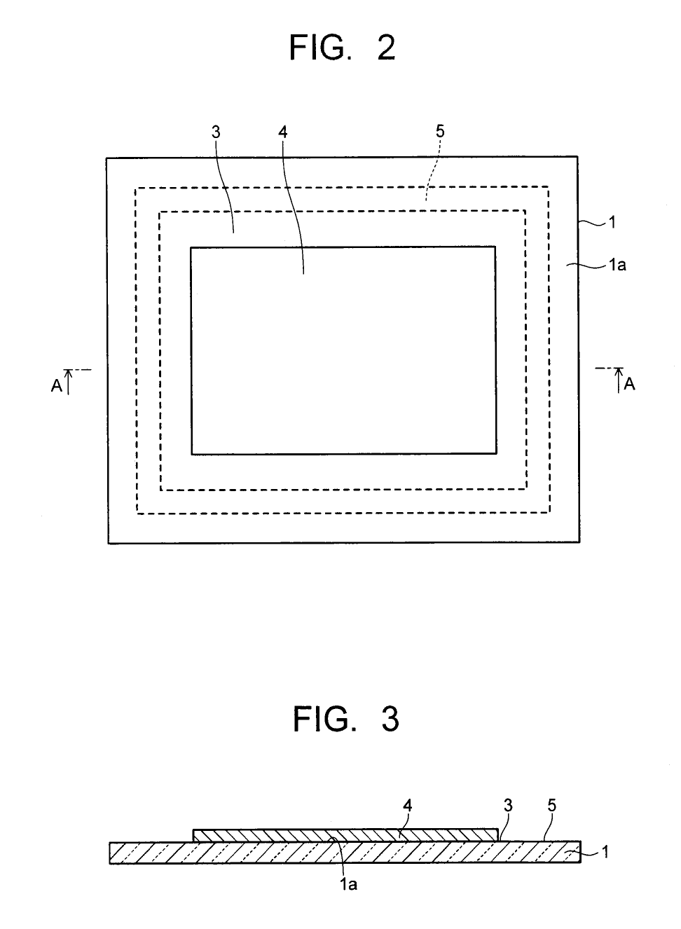

Hereinafter, embodiments for carrying out the present invention will be described with reference to the drawings. FIG. 1A to FIG. 1D are views illustrating one embodiment of manufacturing steps of an electronic device. FIG. 2 to FIG. 6 are views illustrating an example of members used for manufacturing the electronic device.

Examples of the electronic device are FPD such as OELD, FED, PDP, and LCD, lighting devices using a light-emitting element such as an OEL element, and sealed-type solar cells such as a dye-sensitized solar cell, a thin-film silicon solar cell, a compound semiconductor-based solar cell, and an organic thin-film solar cell.

The electronic device is fabricated as illustrated in FIG. 1A to FIG. 1D, for instance. Specifically, as illustrated in FIG. 1A, a first substrate 1 having an electronic element part 4 on a main surface 1a and a second substrate 2 having a frame-shaped sealing material layer 7 on a main surface 2a are prepared, and as illustrated in FIG. 1B, the first substrate 1 and the second substrate 2 are stacked so that the main surface 1a and the main surface 2a face each other. Next, as illustrated in FIG. 1C, the sealing material layer 7 is irradiated with laser light 10 to be melted and bonded, thereby forming a sealing layer 11, and as illustrated in FIG. 1D, an electronic device 12 in which the electronic element part 4 is hermetically sealed between the first substrate 1 and the second substrate 2 by the sealing layer 11 is fabricated.

In fabricating the electronic device 12, the first substrate 1 and the second substrate 2 are first prepared (corresponding to a later-described substrate preparation step). As the first substrate 1 and the second substrate 2, glass substrates made of no-alkali glass, soda lime glass, or the like having a well-known composition are used, for instance. Alternatively, as the first substrate 1 and the second substrate 2, glass ceramics substrates made of glass ceramics in which a ceramics powder is dispersed in glass are used as required.

The no-alkali glass has a coefficient of thermal expansion of about 30 to 50 (×10⁻⁷/K). The soda lime glass has a coefficient of thermal expansion of about 80 to 90 (×10⁻⁷/K). A typical glass composition of the no-alkali glass is a composition containing, by mass %, 50 to 70% of SiO₂, 1 to 20% of Al₂O₃, 0 to 15% of B₂O₃, 0 to 30% of MgO, 0 to 30% of CaO, 0 to 30% of SrO, and 0 to 30% of BaO. A typical glass composition of the soda lime glass is a composition containing, by mass %, 55 to 75% of SiO₂, 0.5 to 10% of Al₂O₃, 2 to 10% of CaO, 0 to 10% of SrO, 1 to 10% of Na₂O, and 0 to 10% of K₂O. Note that the glass composition is not limited to these. Further, at least one of the first substrate 1 and the second substrate 2 may be chemical strengthened glass or the like.

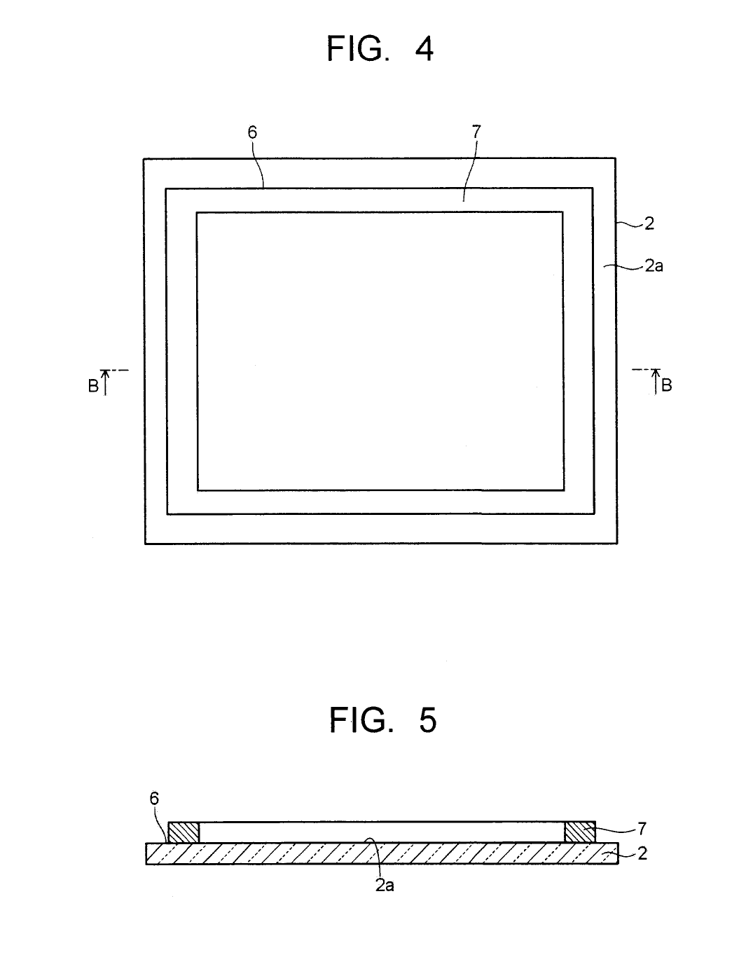

The first substrate 1 having the electronic element part 4 on the main surface 1a, which is illustrated in FIG. 1A, is illustrated in FIG. 2 and FIG. 3. And the second substrate 2 having the frame-shaped sealing material layer 7 on the main surface 2a, which is illustrated in FIG. 1A, corresponding to a member with a sealing material layer of this embodiment, is illustrated in FIG. 4 and FIG. 5. In this description, the main surface and the surface of the substrate are used as meaning the same.

As illustrated in FIG. 2 and FIG. 3, the first substrate 1 has the surface 1a on which an element region 3 is provided. On the element region 3, the electronic element part 4 according to an electronic device being a object is provided. The electronic element part 4 includes, for example, an OEL element if the electronic device is OELD or OEL lighting, an electron emitting element if it is FED, a plasma light-emitting element if it is PDP, a liquid crystal display element if it is LCD, and a solar cell element if it is a solar cell. The electronic element part 4 including a light emitting element such as the liquid crystal display element, the plasma light-emitting element, or the OEL element, a display element such as the liquid crystal display element, the solar cell element such as a dye-sensitized solar cell element, or the like has various kinds of well-known structures. The element structure of the electronic element part 4 is not particularly limited. On a peripheral portion of the surface 1a of the first substrate 1, a first sealing region 5 in a frame shape is provided along an outer periphery of the element region 3.

The electronic element part 4 is provided between the surface 1a of the first substrate 1 and the surface 2a of the second substrate 2. In the manufacturing steps of the electronic device illustrated in FIG. 1A to FIG. 1D, the first substrate 1 is a substrate for element mounting on whose surface 1a the element structure such as an OEL element or a PDP element is provided as the electronic element part 4. The second substrate 2 is a sealing substrate sealing the electronic element part 4 formed on the surface 1a of the first substrate 1. However, the structure of the electronic element part 4 is not limited to this.

For example, when the electronic element part 4 is the dye-sensitized solar cell element or the like, element films such as wiring films and electrode films which form the element structure are formed on each of the surface 1a and the surface 2a. The element films forming the electronic element part 4 and the element structure based on these are formed on at least one of the surface 1a and the surface 2a. Further, on the surface 2a of the second substrate 2 forming the sealing substrate, organic resin films such as color filters are sometimes formed as previously described.

As illustrated in FIG. 4 and FIG. 5, the second substrate 2 has the surface 2a facing the surface 1a of the first substrate 1. On a peripheral portion of the surface 2a, a second sealing region 6 in a frame shape corresponding to the first sealing region 5 is provided. The second sealing region 6 is a formation region of the sealing material layer 7 as the member with the sealing material layer and is a formation region of the sealing layer 11 in the electronic device 12. Further, the first sealing region 5 is a formation region of the sealing layer 11 in the electronic device 12.

On the sealing region 6 of the second substrate 2, the sealing material layer 7 is formed all along a peripheral portion of the second substrate 2 as illustrated in FIG. 1A, FIG. 4, and FIG. 5. The sealing material layer 7 is a fired layer of a sealing material containing sealing glass and a low-expansion filler. The sealing material can contain a laser absorbent as required and can further contain other additives and so on.

The sealing material layer 7 has a first region on the second substrate 2 side with respect to a center of the layer in terms of a thickness direction and has a second region opposite the second substrate 2 with respect to the center. Further, in a cross section of the sealing material layer 7 taken along the thickness direction, the sealing material layer 7 has a part where a ratio A/B between a proportion “A” of an area of the low-expansion filler occupying an area of the first region and a proportion “B” of an area of the low-expansion filler occupying an area of the second region is less than 1.0.

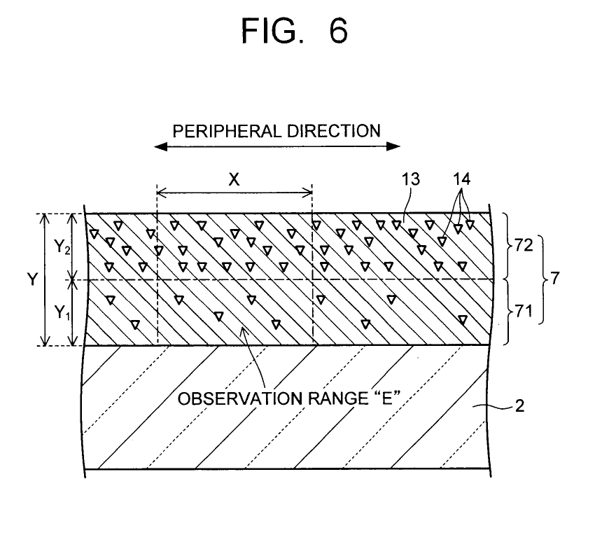

FIG. 6 is a cross-sectional view schematically illustrating the part where the ratio A/B is less than 1.0 in the sealing material layer 7. Here, FIG. 6 is an enlarged cross-sectional view of part of the second substrate 2 and the sealing material layer 7 illustrated in FIG. 4 and FIG. 5, and is a cross-sectional view illustrating a cross section that is perpendicular to a width direction of the sealing material layer 7, that is, a cross section parallel to a peripheral direction, and is a cross section taken along the thickness direction. An example of such a cross section is one passing the center of the sealing material layer 7 in terms of the width direction. Note the reference 13 denotes the sealing glass and the reference 14 denotes the low-expansion filler.

Note that the part where the ratio A/B is less than 1.0 is not limited to one observed in the aforesaid cross section perpendicular to the width direction of the sealing material layer 7. For example, it may be one observed in a cross section perpendicular to the peripheral direction of the sealing material layer 7, though not shown. In any case, a width “X” in a horizontal direction of an observation range “E” where to find the ratio A/B may be equal to or more than twice a film thickness in view of reducing a measurement error of the ratio A/B, but generally, the width “X” is preferably about three times the film thickness. Note that a depth “Y” in the thickness direction of the observation range “E” is the whole thickness of the sealing material layer 7.

Specifically, if the ratio A/B is less than 1.0 in the aforesaid cross section in any part of the sealing material layer 7 when the width “X” of the observation range “E” in the horizontal direction is equal to or more than twice the film thickness of the sealing material layer 7 and in the vertical direction is the whole thickness “Y” of the sealing material layer 7, the sealing material layer 7 is regarded as having the part where the ratio A/B is less than 1.0.

The sealing material layer 7 is divided into the first region 71 being the second substrate 2 side region with respect to the center in terms of the thickness direction and the second region 72 being the region opposite the second substrate 2 with respect to the center, for convenience sake.

The proportion “A” is the proportion of the area of the low-expansion filler occupying the area of the first region in the aforesaid cross section. Here, a thickness of the first region 71 is represented by Y₁ and a thickness of the second region 72 is represented by Y₂. When the observation range “E” is observed in the aforesaid cross section, the area of the first region 71 (the total area including the area of the low-expansion filler 14), which is represented by S₁₀, is found by S₁₀=Y₁×X, and the proportion “A” is expressed by S₁₁/S₁₀, where S₁₁ is the area occupied by the low-expansion filler 14 included in the first region 71 in the observation range “E”.

Similarly, the proportion “B” is the proportion of the area of the low-expansion filler occupying the area of the second region in the aforesaid cross section. When the aforesaid cross section is observed in the observation range “E”, the area of the second region 72 (total area including the area of the low-expansion filler 14), which is represented by S₂₀, is found by S₂₀=Y₂×X, and the proportion “B” is expressed by S₂₁/S₂₀, where S₂₁ is the area occupied by the low-expansion filler 14 included in the second region 72 in the observation range “E”.

In this manner, the proportion “A” and the proportion “B” in the observation range “E” is found, for instance, and the ratio A/B between the proportion “A” and the proportion “B” in the observation range “E” is found. The sealing material layer 7 has the part where the aforesaid ratio A/B between the proportion “A” and the proportion “B” is less than 1.0. That is, it has a part where the proportion “A” of the low-expansion filler 14 in the first region 71 is smaller than the proportion “B” of the low-expansion filler 14 in the second region 72.

In the part where the aforesaid ratio A/B is less than 1.0 in the sealing material layer 7, a proportion of the sealing glass 13 in the first region 71 is large since the proportion “A” of the low-expansion filler 14 therein is small. When the proportion of the sealing glass 13 in the first region 71 is large, an effective bonding area with the second substrate 2 becomes large. Consequently, adhesive strength of the sealing material layer 7 with the second substrate 2 becomes high.

Further, in the case where the sealing material layer 7 is irradiated with the sealing laser light through the second substrate 2, when the proportion “A” of the low-expansion filler 14 in the first region 71 is small, the scattering of the sealing laser light in the first region 71 is suppressed. Consequently, the sealing laser light easily reaches the second region 72, and the entire sealing material layer 7 is uniformly heated with ease. Further, since the excessive heating of the first region 71 is suppressed, breakage of the second substrate 2 adjacent to the first region 71 is suppressed.

From a viewpoint of obtaining the aforesaid effects, the ratio A/B is preferably 0.9 or less, more preferably 0.8 or less, and still more preferably 0.7 or less. A lower limit value of the ratio A/B is not particularly limited and may be 0 (zero), but is preferably 0.1 or more and more preferably 0.3 or more.

The part where the ratio A/B is less than 1.0 may exist in at least part of the sealing material layer 7, and its position and range are not necessarily limited. In this embodiment, if the ratio A/B is less than 1.0 at, for example, one place of the aforesaid observation range “E”, the sealing material layer 7 is regarded as having the part where the ratio A/B is less than 1.0. However, in view of obtaining the aforesaid effects, the larger the number of the parts where the ratio A/B is less than 1.0, the more preferable. A presence range of the part where the ratio A/B is less than 1.0 is especially preferably a 90% range or larger of a peripheral direction length of the sealing material layer 7.

The presence range of the part where the ratio A/B is less than 1.0 can be found by, for example, observing the cross section perpendicular to the width direction of the sealing material layer 7 as illustrated in FIG. 6 while moving sequentially in the peripheral direction. An example of an observation method is a scanning electron microscope. An example of the aforesaid cross section is a cross section passing the center of the sealing material layer 7 in terms of the width direction. For example, the observation range “E” whose width “X” in the horizontal direction (in this case, the peripheral direction) is 15 μm and whose depth “Y” in the thickness direction is the whole thickness of the sealing material layer 7 is observed while the observation range “E” is moved in the peripheral direction. Incidentally, when a range where the ratio A/B is constant is obvious from a manufacturing method or the like, the presence range of the part where the ratio A/B is less than 1.0 may be found by finding the ratio A/B only for both end portions of such a range.

The proportions A, B are not particularly limited, provided that the ratio A/B becomes less than 1.0, but the proportion “A” is preferably less than 0.17 and the proportion “B” is preferably 0.17 or more. When the proportion “A” is less than 0.17, the scattering of the sealing laser light in the first region 71 is effectively suppressed. Consequently, the sealing laser light easily reaches the second region 72 and the whole sealing material layer 7 is uniformly heated with ease. When the proportion “B” is 0.17 or more, a coefficient of thermal expansion of the sealing layer approaches coefficients of thermal expansion of the first substrate 1 and the second substrate 2, which is preferable. A lower limit value of the proportion “A” is not particularly limited and may be 0 (zero). An upper limit value of the proportion “B” is not necessarily limited, but is preferably 0.3 or less because adhesiveness with the first substrate 1 becomes good at the time of the sealing.

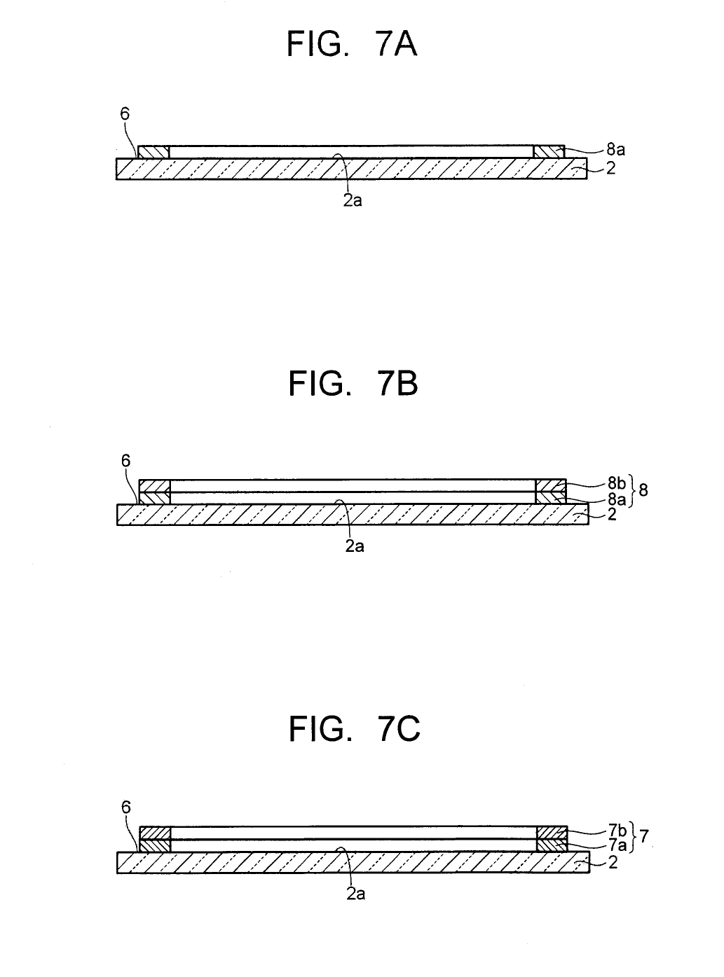

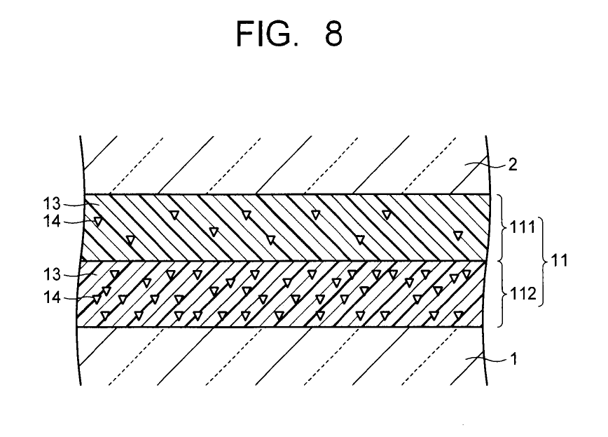

Hereinafter, a method of manufacturing the member with the sealing material layer, that is, a method of forming the frame-shaped sealing material layer 7 on the surface 2a of the second substrate 2 will be described with reference to FIG. 7A to FIG. 7C. In the below, a description will be given of a method in which two kinds of sealing material pastes different in content ratio of the low-expansion filler to total of the sealing glass and the low-expansion filler are applied.

The member with the sealing material layer can be manufactured by, for example, a method including (1) a substrate preparation step, (2) a sealing material paste preparation step, (3) a first coating step, (4) a second coating step, and (5) a firing step which will be described below.

(1) The substrate preparation step is a step of preparing a substrate having a frame-shaped sealing region.

(2) The sealing material paste preparing step is a step of preparing a first sealing material paste by mixing a first sealing material containing sealing glass and a low-expansion filler with a vehicle containing an organic binder and preparing a second sealing material paste by mixing a second sealing material containing sealing glass and a low-expansion filler with a vehicle containing an organic binder. At this time, for example, a ratio a/b between a volume content proportion “a” of the low-expansion filler in the first sealing material and a volume content proportion “b” of the low-expansion filler in the second sealing material is set to less than 1.0.

(3) The first coating step is a step of forming a first frame-shaped coating layer by applying the first sealing material paste prepared in (2) on the sealing region (refer to FIG. 7A).

(4) The second coating step is a step of forming a second frame-shaped coating layer by applying the second sealing material paste prepared in (2) on the first frame-shaped coating layer (refer to FIG. 7B).

(5) The firing step is a step of forming a sealing material layer by heating the first frame-shaped coating layer and the second frame-shaped coating layer (refer to FIG. 7C).

The substrate can be prepared in the same manner as when the first substrate 1 and the second substrate 2 in the aforesaid electronic device are prepared. Additionally, the first sealing material is prepared by compounding the low-expansion filler and optionally a laser absorbent and so on with the sealing glass, and the first sealing material is mixed with the vehicle, whereby the first sealing material paste is prepared. Further, the second sealing material is prepared by compounding the low-expansion filler and optionally a laser absorbent and so on with the sealing glass, and the second sealing material is mixed with the vehicle, whereby the second sealing material paste is prepared.

At this time, the content proportions of the low-expansion fillers in the respective sealing materials are adjusted so that the ratio a/b between the volume proportion “a” of the low-expansion filler to the total amount of the sealing glass, the low-expansion filler, and the optionally compounded laser absorbent and so on in the first sealing material and the volume proportion “b” of the low-expansion filler to the total amount of the sealing glass, the low-expansion filler, and the optionally compounded laser absorbent and so on in the second sealing material becomes less than 1.0.

The volume proportion “a” of the low-expansion filler to the total amount of the first sealing material, for example, consisting of the sealing glass and the low-expansion filler, is preferably 0.1 or less. In such a case, the scattering of the sealing laser light in the first region 71 is effectively suppressed. Consequently, the sealing laser light easily reaches the second region 72 and the whole sealing material layer 7 is uniformly heated with ease. The proportion “a” is more preferably 0.05 or less. A lower limit value of the proportion “a” is not particularly limited and may be 0 (zero), but is preferably 0.01 or more and more preferably 0.03 or more. Even when the first sealing material contains the laser absorbent and so on, the above preferable range of the proportion “a” is applicable.

The volume proportion “b” of the low-expansion filler to the total amount of the second sealing material, for example, consisting of the sealing glass and the low-expansion filler, is preferably 0.05 or more. In such a case, the coefficient of thermal expansion of the sealing layer 11 approaches the coefficients of thermal expansion of the first substrate 1 and the second substrate 2, which is preferable. The proportion “b” is more preferably 0.1 or more. However, when the proportion “b” is excessively large, flowability at the time of melting deteriorates, which is liable to lower adhesiveness with the first substrate 1. Therefore, the proportion “b” is preferably 0.4 or less. Even when the second sealing material contains the laser absorbent and so on, the above preferable range of the proportion “b” is applicable.

As the sealing glass, low-melting-point glass such as tin-phosphoric acid-based glass, bismuth-based glass, vanadium-based glass, or lead-based glass is used, for instance. Among them, low-melting-point sealing glass made of tin-phosphoric acid-based glass or bismuth-based glass is preferable in consideration of sealability (adhesiveness) to the first substrate 1 and the second substrate 2 and reliability thereof (adhesion reliability and hermeticity), further an influence on environments and human bodies, and so on.

The tin-phosphoric acid-based glass preferably has a composition containing 55 to 68 mole % of SnO, 0.5 to 5 mole % of SnO₂, and 20 to 40 mole % of P₂O₅ (basically, the total amount is 100 mole %).

The glass formed of the aforesaid three components is low in glass transition point and is suitable as a sealing material for low temperatures, but a component such as SiO₂ forming a skeletal structure of the glass, components such as ZnO, B₂O₃, Al₂O₃, WO₃, MoO₃, Nb₂O₅, TiO₂, ZrO₂, Li₂O, Na₂O, K₂O, Cs₂O, MgO, CaO, SrO, and BaO for stabilizing the glass, and so on may be contained as optional components. However, when the content of the optional components is too large, the glass becomes unstable to cause devitrification, and further the glass transition point and softening point are liable to increase, and therefore, the total content of the optional components is preferably 30 mole % or less. The glass composition in this case is adjusted so that the total amount of the basic components and the optional components becomes basically 100 mole %.

The bismuth-based glass preferably has a composition containing 70 to 90 mass % of Bi₂O₃, 1 to 20 mass % of ZnO, and 2 to 12 mass % of B₂O₃ (basically, the total amount is 100 mass %).

The glass formed of the aforesaid three components is low in glass transition point and is suitable for a sealing material for low temperatures, but optional components such as Al₂O₃, CeO₂, SiO₂, Ag₂O, MoO₃, Nb₂O₅, Ta₂O₅, Ga₂O₃, Sb₂O₃, Li₂O, Na₂O, K₂O, Cs₂O, CaO, SrO, BaO, WO₃, P₂O₅, and SnOx (x is 1 or 2) may be contained. However, when the content of the optional components is too large, the glass becomes unstable to cause devitrification, and further the glass transition point and softening point are likely to increase, and therefore, the total content of the optional components is preferably 30 mass % or less. The glass composition in this case is adjusted so that the total amount of the basic components and the optional components becomes basically 100 mass %.

The low-expansion filler is lower in coefficient of thermal expansion than the sealing glass. The low-expansion filler is preferably at least one kind selected from silica, alumina, zirconia, zirconium silicate, aluminum titanate, mullite, cordierite, eucryptite, spodumene, a zirconium phosphate-based compound, a quartz solid solution, soda lime glass, and borosilicate glass. Examples of the zirconium phosphate-based compound are (ZrO)₂P₂O₇, NaZr₂(PO₄)₃, KZr₂(PO₄)₃, Ca_{0.5}Zr₂(PO₄)₃, NbZr(PO₄)₃, Zr₂(WO₃)(PO₄)₂, and a complex compound of these.

The sealing material preferably contains the laser absorbent. As the laser absorbent, at least one kind of metal selected from Fe, Cr, Mn, Co, Ni, and Cu, and/or at least one kind of a metal compound such as an oxide containing the aforesaid metal or the like, are (is) used, for instance.

The content of the laser absorbent is preferably within a range of 0.1 to 40 vol % to the sealing material. When the content of the laser absorbent is less than 0.1 vol %, it may not be possible to melt the sealing material layer 7 sufficiently. When the content of the laser absorbent is over 40 vol %, heat is liable to be generated locally near an interface with the second substrate 2, and flowability of the sealing material is liable to deteriorate at the time of its melting to lower adhesiveness with the first substrate 1. The content of the laser absorbent is preferably 37 vol % or less.

The vehicle is prepared by melting an organic binder in a solvent. As the organic binder, used is, for example: cellulose-based resin such as methyl cellulose, ethyl cellulose, carboxymethyl cellulose, oxyethyl cellulose, benzyl cellulose, propyl cellulose, or nitrocellulose; organic resin such as acrylic resin obtained by polymerizing one kind or more of acrylic monomers such as methyl methacrylate, ethyl methacrylate, butyl methacrylate, 2-hydroxyethyl methacrylate, butyl acrylate, and 2-hydroxyethyl acrylate; or aliphatic polyolefin-based carbonate resin such as polypropylene carbonate. As the solvent, in the case of the cellulose-based resin, a solvent such as terpineol, butyl carbitol acetate, or ethylcarbitol acetate is used, in the case of the acrylic resin, a solvent such as methyl ethyl ketone, terpineol, butyl carbitol acetate, or ethyl carbitol acetate is used, and in the case of the aliphatic polyolefin-based carbonate, a solvent such as propylene carbonate or triacetin is used.

A viscosity of each of the sealing material pastes may be adjusted to a viscosity suitable for a coating apparatus or the like, and can be adjusted by a ratio of the organic binder and the solvent or a ratio of the sealing material and the vehicle. Well-known additives in a glass paste such as a defoaming agent and a dispersing agent may be added to each of the sealing material pastes. A well-known method using a mixer of a rotation type having stirring blades, a roll mill, a ball mill, or the like is applicable to the preparation of the sealing material pastes.

Next, as illustrated in FIG. 7A, the first sealing material paste is applied along the whole periphery of the frame-shaped sealing region 6 provided on the peripheral portion of the second substrate 2 and is dried, whereby a first frame-shaped coating layer 8a is formed (first coating step). Further, as illustrated in FIG. 7B, the second sealing material paste is applied on the first frame-shaped coating layer 8a and is dried, whereby a second frame-shaped coating layer 8b is formed (second coating step). Consequently, a frame-shaped coating layer 8 in which the first frame-shaped coating layer 8a and the second frame-shaped coating layer 8b are stacked in the order mentioned is formed.

The coating is performed by a printing method such as screen printing or gravure printing or a dispensing method or the like, for instance. The drying is preferably performed at a temperature equal to or higher than 120° C. for ten minutes or longer in order to remove the solvent. If the solvent remains, it may not be possible to remove the organic binder sufficiently in the later firing step.

A thickness of the frame-shaped coating layer 8 is preferably set so that a thickness after the firing becomes 1μm or more, that is, so that a thickness of the sealing material layer 7 becomes 1 μm or more. In the case of such a thickness, by adjusting a formation condition, a firing condition, and so on, it is possible to fire the frame-shaped coating layer 8 well. The thickness of the frame-shaped coating layer 8 is more preferably set so that the thickness after the firing becomes 150 μm or less. In view of uniform firing, the thickness of the frame-shaped coating layer 8 is still more preferably set so that the thickness after the firing becomes 20 μm or less. A width of the frame-shaped coating layer 8 is preferably set so that a width after the firing becomes 0.1 to 5.0 mm, more preferably 0.2 to 3.0 mm, and still more preferably 0.3 to 2.0 mm

Thicknesses of the first frame-shaped coating layer 8a and the second frame-shaped coating layer 8b are not necessarily limited, provided that the ratio A/B becomes less than 1.0 when the sealing material layer 7 is formed, but a ratio Hₐ/H_{b} is preferably 0.1 to 2.0, where Hₐ is the thickness of the first frame-shaped coating layer 8a and H_{b} is the thickness of the second frame-shaped coating layer 8b.

Further, as illustrated in FIG. 7C, the frame-shaped coating layer 8 is heated, whereby the sealing materials are fired while the organic binder in the frame-shaped coating layer 8 is removed, and the sealing material layer 7 with a double-layer structure in which the first sealing material layer 7a and the second sealing material layer 7b are stacked in sequence from the second substrate 2 is obtained. In the firing, for example, the heating is performed to a temperature equal to or higher than the softening point of the sealing glass, for example, to a temperature higher than the softening point by 10 to 100° C. by using a firing furnace. Note that in this description, the glass softening point is defined as a temperature of a fourth inflection point of differential thermal analysis (DTA).

Here, when the sealing material layer 7 is composed of the first sealing material layer 7a made of the first sealing material paste and the second sealing material layer 7b made of the second sealing material paste and the thickness of the sealing material layer 7a and the thickness of the sealing material layer 7b are Y₁ and Y₂ respectively, a cross section taken along the thickness direction of the sealing material layer 7 corresponds to the cross section illustrated in FIG. 6. In this case, the cross section of the sealing material layer 7a corresponds to the first region 71 and the cross section of the sealing material layer 7b corresponds to the second region 72.

Therefore, according to the method of applying two kinds of the sealing material pastes, by adjusting the content proportions of the low-expansion filler in the respective sealing materials so that, concretely, the ratio a/b between the volume proportion “a” of the low-expansion filler in the first sealing material and the volume proportion “b” of the low-expansion filler in the second sealing material becomes less than 1.0, it is possible to set the ratio A/B between the proportion “A” of the area of the low-expansion filler occupying the area of the first region and the proportion “B” of the area of the low-expansion filler occupying the area of the second region to less than 1.0 in the cross section taken along the thickness direction of the sealing material layer 7.

Incidentally, in the case of the method of repeatedly applying the sealing material pastes and uniformly firing the whole in the firing furnace or the like as described above, the stacked structure of the frame-shaped coating layer 8 does not basically change before and after the firing. That is, the stacked structure of the sealing material layer 7 and the stacked structure of the frame-shaped coating layer 8 are the same. Note that the stacked structure refers to a mixture ratio of the sealing glass and the low-expansion filler and a dispersion state of the low-expansion filler in each of the layers. Therefore, in the case of the above-described method, if the ratio A/B is less than 1.0 in part of the sealing material layer 7, the ratio A/B basically becomes less than 1.0 in the other parts.

Hitherto, the method of forming the sealing material layer 7 is described, taking, as an example, the method of applying two kinds of the sealing material pastes in ascending order of the content proportion of the low-expansion filler, each being applied once, but the formation method of the sealing material layer is not limited to such a method, provided that it is a formation method that causes the obtained sealing material layer 7 to have a part where the aforesaid ratio A/B is less than 1.0. For example, two kinds of the sealing material pastes may be alternately applied, each being repeatedly applied twice or more. Alternatively, three kinds of sealing material pastes or more different in the content proportion of the low-expansion filler in the sealing material may be used as the sealing material paste.

Further, the sealing material layer 7 may be formed by a method in which the firing is performed by the irradiation with firing laser light without using the firing furnace. For example, after one kind of the sealing material paste is applied to form the frame-shaped coating layer 8 with a single-layer structure, the sealing material layer 7 may be formed by radiating the firing laser light while scanning the firing laser light along the frame-shaped coating layer 8. Such a formation method can be adopted as the formation method of the sealing material layer 7, provided that the obtained sealing material layer 7 can be formed to have a part where the ratio A/B becomes less than 1.0 by the adjustment of power, a scanning speed, and the like of the firing laser light.

After the sealing material layer 7 is formed on the second substrate 2, that is, after the member with the sealing material layer is manufactured, the first substrate 1 and the second substrate 2 on whose peripheral portion the sealing material layer 7 is formed are stacked via the sealing material layer 7 so that the surface 1a and the surface 2a face each other, whereby an assembly is formed, as illustrated in FIG. 1B. Thereafter, as illustrated in FIG. 1C, the sealing laser light 10 is radiated to the sealing material layer 7 through the second substrate 2 from above the second substrate 2 of the assembly. The sealing laser light 10 is not particularly limited, and desired laser light such as diode laser, carbon dioxide gas laser, excimer laser, YAG laser, or HeNe laser is usable.

In the case where the sealing laser light is thus radiated to the sealing material layer 7 through the second substrate 2, when the proportion “A” of the low-expansion filler 14 in the first region 71 first reached by the sealing laser light in the sealing material layer 7 is small as illustrated in FIG. 6, the scattering of the sealing laser light in the first region 71 is suppressed. Consequently, the sealing laser light easily reaches the second region 72 and the whole sealing material layer 7 is uniformly heated with ease. Further, since the excessive heating of the first region 71 is suppressed, breakage of the second substrate 2 adjacent to the first region 71 is suppressed, which is preferable.

Incidentally, the sealing laser light 10 may be radiated to the sealing material layer 7 through the first substrate 1 from under the first substrate 1 of the assembly as required. Alternatively, the sealing laser light 10 may be radiated both from above the second substrate 2 and from under the first substrate 1.

The sealing laser light 10 is radiated while being scanned along the sealing material layer 7. The sealing material layer 7 melts sequentially from its part irradiated with the laser light 10 and is rapidly cooled to be solidified and is bonded to the first substrate 1 when the irradiation with the sealing laser light 10 ends. Then, by radiating the sealing laser light 10 to the whole periphery of the sealing material layer 7, the sealing layer 11 sealing a gap between the first substrate 1 and the second substrate 2 is formed as illustrated in FIG. 1D. In this manner, the electronic device 12 in which the electronic element part 4 is hermetically sealed between the first substrate 1 and the second substrate 2 is fabricated.

A power density of the sealing laser light 10 is preferably 400 to 1000 W/cm². When the power density is less than 400 W/cm², it may not be possible to uniformly heat the whole sealing material layer 7. When the power density is over 1000 W/cm², the second substrate 2 is excessively heated and is likely to suffer a crack, a fracture, and the like. Further, a beam diameter of the sealing laser light 10 is preferably 0.5 to 3 mm. Note that the beam diameter is defined in a region where beam intensity becomes 13.5% of the maximum beam intensity.

A scanning speed of the sealing laser light 10 is preferably within a range of 3 to 20 mm/s. When the scanning speed is less than 3 mm/s, a sealing speed reduces and the sealing layer 11 cannot be efficiently formed. On the other hand, when the scanning speed is over 20 mm/s, the sealing material layer 7 is not sufficiently heated, and sealability may not become good.

FIG. 8 is a cross-sectional view schematically illustrating the sealing layer 11 when the electronic device is manufactured by using the second substrate 2 with the sealing material layer 7 whose cross section in the thickness direction is illustrated in FIG. 6, for instance. The stacked structure of the sealing material layer 7 does not change before and after the irradiation with the sealing laser light 10, and therefore, the sealing layer 11 has the same stacked structure as that of the sealing material layer 7. Note that the stacked structure refers to a dispersion state of the low-expansion filler including the ratio of the sealing glass and the low-expansion filler in each layer.

Specifically, the sealing layer 11 has a third region 111 on the second substrate 2 side with respect to the center of the sealing layer 11 in terms of the thickness direction and has a fourth region 112 opposite the second substrate 2 with respect to the center. The third region 111 in the sealing layer 11 is a region corresponding to the first region 71 in the sealing material layer 7, and the fourth region 112 is a region corresponding to the second region 72 in the sealing material layer 7.

Let a proportion of an area of the low-expansion filler occupying an area of the third region 111 be C and let a proportion of an area of the low-expansion filler occupying an area of the fourth region 112 be D in a cross section taken along the thickness direction of the sealing layer 11, the proportion “C” is equal to the proportion “A” in the sealing material layer 7, and the proportion “D” is equal to the proportion “B” in the sealing material layer 7. Therefore, when the sealing material layer 7 has the part where the ratio A/B is less than 1.0, the sealing layer 11 also has a part where a ratio C/D is less than 1.0.

In the method of manufacturing the electronic device of the embodiment, adhesive strength of the sealing material layer is high, and not only the sealing material layer is uniformly heated but also is prevented from being excessively heated. Consequently, it is possible to form the sealing layer well, and the electronic device whose function deterioration and reliability deterioration are suppressed can be manufactured with good reproducibility.

### EXAMPLES

Hereinafter, a detailed description will be given with reference to examples. Note that the present invention is not limited to these examples at all.

### Example 1

A bismuth-based glass frit (softening temperature: 410° C.) that had a composition containing 83 mass % of Bi₂O₃, 5 mass % of B₂O₃, 11 mass % of ZnO, and 1 mass % of Al₂O₃ and had a 1 μm average particle size, a cordierite powder as a low-expansion filler that had a 0.9 μm average particle size, and a laser absorbent that had a composition of Fe₂O₃—Al₂O₃—MnO—CuO and had a 1.9 μm average particle size were prepared.

The average particle sizes of the bismuth-based glass powder, the cordierite powder, and the laser absorbent were measured and calculated by a laser diffraction method.

84.0 vol % of the aforesaid bismuth-based glass frit, 5 vol % of the cordierite powder, and 11 vol % of the laser absorbent were mixed to fabricate a first sealing material. 90 mass % of the sealing material was mixed with a 10 mass % of vehicle to prepare a first sealing material paste. In the vehicle, ethyl cellulose (5 mass %) as an organic binder was dissolved in a solvent (95 mass %) made of 2,2,4-trimethyl-1,3-pentanediol monoisobutyrate.

In addition, a 73 vol % of bismuth-based glass frit, a 16 vol % of cordierite powder, and an 11 vol % of laser absorbent were mixed to fabricate a second sealing material. 90 mass % of the sealing material and a 10 mass % of vehicle were mixed to prepare a second sealing material paste. Note that the bismuth-based glass frit, the cordierite powder, the laser absorbent, and the vehicle are the same as those used in the first sealing material and the first sealing material paste.

Next, the first sealing material paste was applied on a sealing region of a substrate which was made of no-alkali glass having a coefficient of thermal expansion of 38×10⁻⁷/K, had a frame-shaped sealing region, and had a: 90 mm×90 mm (dimension)×0.7 mm (thickness), by a dispensing method, followed by drying under a condition of 120° C.×ten minutes, whereby a first frame-shaped coating layer was formed. Further, the second sealing material paste was applied on the first frame-shaped coating layer by a dispensing method, followed by drying under a condition of 120° C.×ten minutes, whereby a second frame-shaped coating layer was formed. Then, by using a firing furnace, the whole was heated to 480° C., whereby a member with a sealing material layer having a sealing material layer with a double-layer structure in which the first sealing material layer and the second sealing material layer were stacked on the substrate in the order mentioned was manufactured. Note that a thickness of the first sealing material layer is 3 μm and a thickness of the second sealing material layer is 3 μm. Further, a width of the first sealing material layer and a width of the second sealing material layer are both 500 μm.

Regarding this member with the sealing material layer, a cross section that is perpendicular to a width direction of the sealing material layer and passing a center of the sealing material layer in terms of the width direction was observed by a scanning electron microscope. Based on the observation, an area proportion “A” of the low-expansion filler contained in a first region being a region on the substrate side with respect to the center of the sealing material layer in terms of the thickness direction was found, and an area proportion “B” of the low-expansion filler contained in a second region being a region opposite the substrate with respect to the center in terms of the thickness direction was found. Incidentally, the proportions A, B were found by using two-dimensional image analysis software (manufactured by Mitani Corporation, trade name: WinRoof). Further, regarding an observation range “E” where to find the proportions A, B, a width “X” in a horizontal direction (here, a peripheral direction of the sealing material layer) was set to 20 μm, and a depth “Y” in a vertical direction (thickness direction) was set to the thickness of the sealing material layer. Thereafter, a ratio A/B was calculated by using the proportions A, B.

Next, the aforesaid member with the sealing material layer was stacked on another substrate having the same composition and shape as those of the substrate used for the aforesaid member with the sealing material layer. Thereafter, sealing laser light was radiated through the substrate of the member with the sealing material layer while being scanned along the sealing material layer, and the sealing material layer was melted and rapidly cooled to be solidified, whereby a hermetic vessel in which the pair of substrates are sealingly bonded by the sealing layer was fabricated.

The sealing laser light had an 808 nm of wavelength, a 620 W/cm² of power density, and a circular beam shape with a 1.5 mm of diameter. The beam shape was measured by using a laser beam profiler (manufactured by Ophir Optonics Solutions Ltd, device name: BS-USB-SP620), and a diameter with which beam intensity became 13.5% of the maximum beam intensity was set as the beam diameter. The laser power was measured by using a power meter (manufactured by Coherent, Inc., device name: FieldMaxll-TO) and a head (manufactured by Coherent, Inc., device name: PM100-19C). Further, a temperature of the sealing material layer when it was irradiated with the sealing laser light was 630° C., which temperature was measured by a radiation thermometer.

### Example 2

The first sealing material paste described in the example 1 was applied on a sealing region of a substrate which was made of no-alkali glass having a coefficient of thermal expansion of 38×10⁻⁷/K, had a frame-shaped sealing region, and had a 90 mm×90 mm (dimension)×0.7 mm (thickness), by a dispensing method, followed by drying under a condition of 120° C.×ten minutes, whereby a first frame-shaped coating layer was formed.

Next, firing laser light was radiated while being scanned along the aforesaid frame-shaped coating layer, whereby a sealing material layer was formed. When a scanning speed and power of the firing laser light were adjusted, A/B became 0.65. A thickness of the sealing material layer is 5 μm. Further, a width of this sealing material layer is 500 μm.

The aforesaid member with the sealing material layer was stacked on another substrate having the same composition and shape as those of the substrate used for the aforesaid member with the sealing material layer, whereby a hermetic vessel was fabricated in the same manner as that of the example 1.

### Comparative Example 1

A member with a sealing material layer was manufactured in the same manner as that of the example 1 except that proportions A, B and a ratio A/B were changed as shown in Table 1. Incidentally, the proportions A, B and the ratio A/B were adjusted by changing a compounding ratio of a bismuth-based glass frit and a cordierite powder in a first sealing material and a second sealing material. Concretely, the compounding proportion of the cordierite powder in the second sealing material was made smaller than that in the first sealing material. Thereafter, a hermetic vessel was fabricated in the same manner as that of the example 1 except that this member with the sealing material layer was used.

### Comparative Example 2

A hermetic vessel was fabricated in the same manner as that of the comparative example 1 except that a power density of sealing laser light was changed to 707 W/cm².

Thereafter, sealability was evaluated regarding the hermetic vessels of the examples and the comparative examples. In the table “Good” indicates that an outer appearance is good with a crack of the substrate being suppressed and airtightness is good with the exfoliation of the sealing layer being suppressed, and “Poor” indicates that the outer appearance is poor with a crack occurring in the substrate or airtightness is poor with the exfoliation occurring in the sealing layer.

TABLE 1

| | | | | Comparative | Comparative |
|---|---|---|---|---|---|
| | | Example 1 | Example 2 | Example 1 | Example 2 |
| Sealing | A | 0.10 | 0.15 | 0.18 | 0.18 |
| material | B | 0.23 | 0.23 | 0.16 | 0.16 |
| Layer | A/B | 0.43 | 0.65 | 1.1 | 1.1 |
| Sealing | scanning speed [mm/s] | 10 | 10 | 10 | 10 |
| condition | power density [W/cm²] | 620 | 634 | 620 | 707 |
| (sealing laser | temperature of sealing | 630 | 635 | 610 | 640 |
| condition) | material layer [° C.] | | | | |

| | | | | |
|---|---|---|---|---|
| Sealability | Good | Good | Poor | Good |

When the ratio A/B is over 1.0 as in the comparative example 1, part of the sealing layer exfoliates, so that airtightness deteriorates. In order to obtain good sealability with the same ratio A/B, it is necessary to increase the power density of the sealing laser light as in the comparative example 2. On the other hand, when the ratio A/B is less than 1.0 as in the examples 1, 2, good sealability is obtained even when the power density of the sealing laser light is low. Incidentally, in the example 1 and the example 2, the ratios A/B were 0.43 and 0.65 respectively in a 90% range or more of the peripheral direction length of the sealing material layer.

What is claimed is:

1. A member with a sealing material layer, comprising:
a substrate having a frame-shaped sealing region on a main surface; and
a sealing material layer provided on the sealing region and containing sealing glass and a low-expansion filler,
wherein the sealing material layer has a first region on the substrate side with respect to a center of the layer in terms of a thickness direction and a second region opposite the substrate with respect to the center, and has, in a cross section taken along the thickness direction of the sealing material layer, a part where a ratio A/B between a proportion “A” of an area of the low-expansion filler occupying an area of the first region and a proportion “B” of an area of the low-expansion filler occupying an area of the second region is less than 1.0.

2. The member with the sealing material layer according to claim 1,
wherein the part where the ratio A/B is less than 1.0 is provided in a 90% range or more of a peripheral direction length of the sealing material layer.

3. The member with the sealing material layer according to claim 1,
wherein the sealing glass is bismuth-based glass having a composition of 70 to 90 mass % of Bi₂O₃, 1 to 20 mass % of ZnO, and 2 to 12 mass % of B₂O₃.

4. The member with the sealing material layer according to claim 1,
wherein the sealing material layer has a laser absorbent.

5. An electronic device comprising:
a first substrate having a first surface on which a frame-shaped first sealing region is provided;
a second substrate having a second surface on which a second sealing region corresponding to the first sealing region is provided and disposed with the first surface and the second surface facing each other; and
a sealing layer disposed in a frame shape so as to seal an electronic element part between the first substrate and the second substrate,
wherein the sealing layer is formed by melting and bonding a sealing material layer provided on the second sealing region of the second substrate and containing sealing glass and a low-expansion filler, a dispersion state of the low-expansion filler in a cross section taken along a thickness direction of the sealing layer is the same as a dispersion state of the low-expansion filler in a cross section taken along a thickness direction of the sealing material layer, the sealing layer has a third region on the second substrate side with respect to a center of the sealing layer in terms of the thickness direction and a fourth region opposite the second substrate with respect to the center, and has, in a cross section taken along the thickness direction of the sealing layer, a part where a ratio C/D between a proportion “C” of an area of the low-expansion filler occupying an area of the third region and a proportion “D” of an area of the low-expansion filler occupying an area of the fourth region is less than 1.0.

6. The electronic device according to claim 5,
wherein the part where the ratio C/D is less than 1.0 is provided in a 90% range or more of a peripheral direction length of the sealing layer.

7. The electronic device according to claim 5,
wherein the sealing glass is bismuth-based glass having a composition of 70 to 90 mass % of Bi₂O₃, 1 to 20 mass % of ZnO, and 2 to 12 mass % of B₂O₃.

8. The electronic device according to claim 5,
wherein the sealing material layer has a laser absorbent.

9. The electronic device according to claim 5,
wherein the melting and bonding of the sealing material layer are performed by irradiating the sealing material layer with sealing laser light through the second substrate.

10. A method of manufacturing an electronic device, the method comprising:
a substrate preparation step of preparing a first substrate having a first surface on which a frame-shaped first sealing region is provided and a second substrate having a second surface on which a second sealing region corresponding to the first sealing region is provided;
a first coating step of applying a first sealing material paste prepared by mixing a first sealing material containing sealing glass and a low-expansion filler with a vehicle containing an organic binder, on the second sealing region of the second substrate to form a first frame-shaped coating layer;
a second coating step of applying a second sealing material paste prepared by mixing a second sealing material containing sealing glass and a low-expansion filler with a vehicle containing an organic binder, on the first frame-shaped coating layer to form a second frame-shaped coating layer;
a firing step of heating the first frame-shaped coating layer and the second frame-shaped coating layer to form a sealing material layer;
a stacking step of stacking the first substrate and the second substrate via the sealing material layer, with the first surface and the second surface facing each other; and
a sealing step of irradiating the sealing material layer with sealing laser light through the second substrate to melt the sealing material layer to form a sealing layer sealing an electronic element part provided between the first substrate and the second substrate,
wherein a ratio a/b between a volume content proportion “a” of the low-expansion filler in the first sealing material and a volume content proportion “b” of the low-expansion filler in the second sealing material is less than 1.0.

11. The method of manufacturing the electronic device according to claim 10,
wherein the first sealing material contains a laser absorbent.

12. The method of manufacturing the electronic device according to claim 10,
wherein the second sealing material contains a laser absorbent.

13. An electronic device obtained by the manufacturing method according to claim 10.
